(19) United States
(12) Patent Application Publication
(10) Pub. No.: US 2026/0104559 A1
(43) Pub. Date: Apr. 16, 2026

(54) PHOTONIC RECEIVERS

(71) Applicant: GlobalFoundries U.S. Inc., Malta, NY (US)

(72) Inventor: Yusheng Bian, Ballston Lake, NY (US)

(21) Appl. No.: 18/917,185

(22) Filed: Oct. 16, 2024

(51) Int. Cl. G02B 6/42

(52) U.S. Cl. CPC G02B 6/4214

(57) ABSTRACT

Structures for a photonic receiver and methods of forming a photonic receiver. The structure comprises a photodetector including a pad with a side edge and a semiconductor layer configured to absorb light. The structure further comprises a plurality of waveguide core segments. Each waveguide core segment extends outwardly from a respective portion of the side edge of the pad.

### BACKGROUND

The present disclosure relates to photonic chips and, more specifically, to structures for a photonic receiver and methods of forming a photonic receiver.

Photonic chips are used in many applications and systems including, but not limited to, data communication systems and data computation systems. A photonic chip includes a photonic integrated circuit comprised of optical components, such as modulators, polarizers, and photonic couplers, that are used to manipulate light received from a light source, such as a laser or an optical fiber.

Conventional photonic receivers are characterized by complex architectures that may include multiple optical components, such an edge coupler, a polarization splitter rotator, and a photodetector, as well photonic couplers and waveguide cores that transfer light between the optical components. As a result, conventional photonic receivers tend to have an extremely large footprint that inefficiently consumes space on the photonic chip. Conventional photonic receivers also suffer from significant polarization dependent loss, significant power dependent loss due to the material of the waveguide cores needed to connect the different optical components, and significant differential group delay for light of different polarizations.

Improved structures for a photonic receiver and methods of forming a photonic receiver are needed.

### SUMMARY

In an embodiment of the invention, a structure comprises a photodetector including a pad with a side edge and a semiconductor layer configured to absorb light. The structure further comprises a plurality of waveguide core segments. Each of the plurality of waveguide core segments extends outwardly from a respective portion of the side edge of the pad.

In an embodiment of the invention, a method comprises forming a photodetector including a pad with a side edge and a semiconductor layer configured to absorb light. The method further comprises forming a plurality of waveguide core segments. Each of the plurality of waveguide core segments extends outwardly from a respective portion of the side edge of the pad.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 2 is a cross-sectional view taken generally along line 2-2 in FIG. 1.

FIG. 2A is a cross-sectional view taken generally along line 2A-2A in FIG. 1.

FIG. 2B is a cross-sectional view taken generally along line 2B-2B in FIG. 1.

FIG. 3 is a top view of the structure at a fabrication stage of the processing method subsequent to FIG. 1.

FIG. 4 is a cross-sectional view taken generally along line 4-4 in FIG. 3.

FIG. 4A is a cross-sectional view taken generally along line 4A-4A in FIG. 3.

FIG. 5 is a cross-sectional view of a structure in accordance with alternative embodiments of the invention.

FIG. 6 is a cross-sectional view of a structure in accordance with alternative embodiments of the invention.

FIG. 7 is a top view of a structure in accordance with alternative embodiments of the invention.

### DETAILED DESCRIPTION

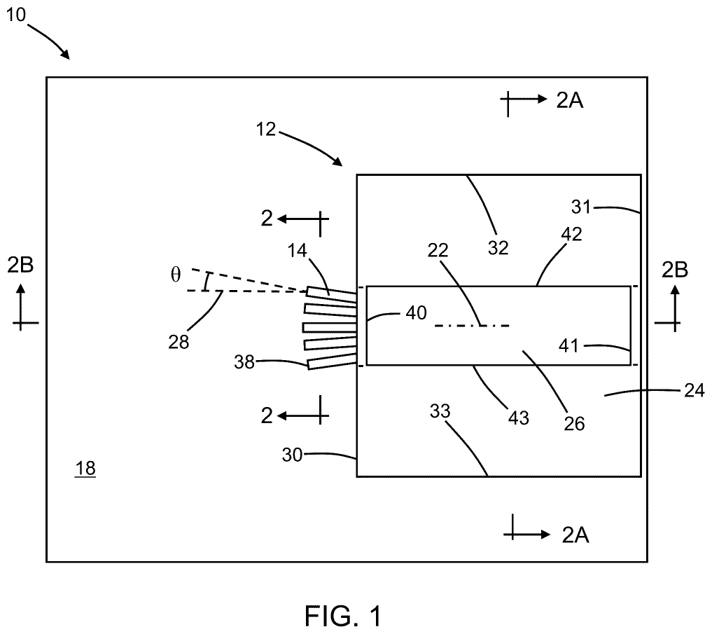

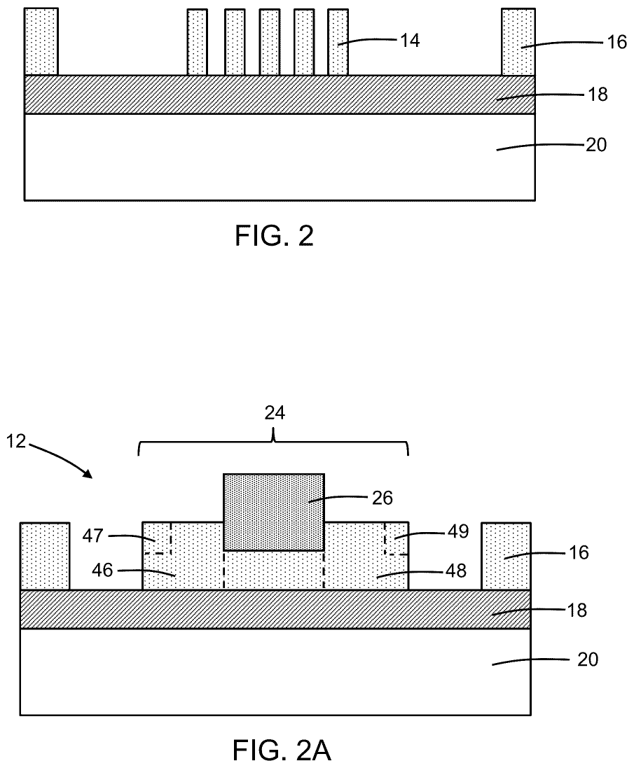

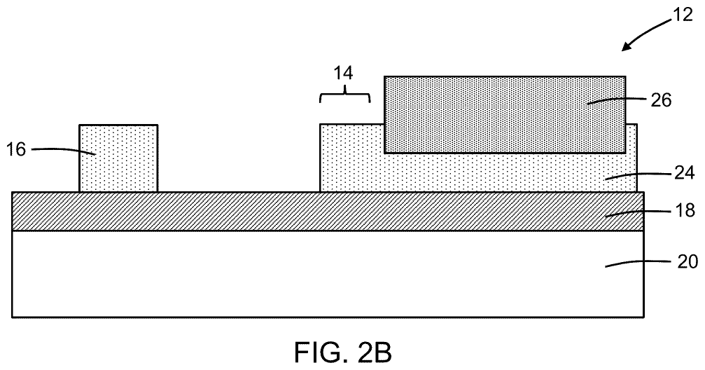

With reference to FIGS. 1, 2, 2A, 2B and in accordance with embodiments of the invention, a structure 10 for a photonic receiver includes a photodetector 12 and waveguide core segments 14 that are disposed on, and over, a dielectric layer 18 and a semiconductor substrate 20. In an embodiment, the dielectric layer 18 may be comprised of a dielectric material, such as an oxide of silicon (e.g., silicon dioxide), and the semiconductor substrate 20 may be comprised of a semiconductor material, such as single-crystal silicon. In an embodiment, the dielectric layer 18 may be a buried oxide layer of a silicon-on-insulator substrate, and the dielectric layer 18 may fully separate the waveguide core segments 14 from the semiconductor substrate 20.

The photodetector 12 includes a pad 24 having a side edge 30, a side edge 31 opposite from the side edge 30, a side edge 32, and a side edge 33 opposite from the side edge 32. The side edges 30, 31, 32, 33 may surround an outer perimeter of the pad 24. The side edges 30, 31, 32, 33 may extend in a vertical direction from a top surface of the pad 24 to a top surface of the dielectric layer 18.

The photodetector 12 includes further includes a semiconductor layer 26 representing a light-absorbing layer. The semiconductor layer 26 may be arranged on the pad 24 with an inward spacing from the outer perimeter of the pad 24. In an embodiment, the semiconductor layer 26 may include a lower portion situated below the top surface of the pad 24 and an upper portion that projects above the top surface of the pad 24. In an alternative embodiment, the semiconductor layer 26 may be positioned directly on the top surface of the pad 24.

The semiconductor layer 26 may be aligned along a longitudinal axis 22 that extends along the length dimension of the semiconductor layer 26. The semiconductor layer 26 may have a perimeter surrounded by a sidewall 40, a sidewall 41 opposite from the sidewall 40, a sidewall 42, and a sidewall 43 opposite from the sidewall 42. The sidewall 40 is positioned adjacent to the side edge 30 of the pad 24, the sidewall 41 is positioned adjacent to the side edge 31 of the pad 24, the sidewall 42 is positioned adjacent to the side edge 32 of the pad 24, and the sidewall 43 is positioned adjacent to the side edge 33 of the pad 24. The longitudinal axis 22 may extend from the sidewall 40 to the sidewall 41. A portion of the pad 24 is laterally positioned between the sidewall 42 of the semiconductor layer 26 and the side edge 32 of the pad 24. Another portion of the pad 24 is laterally positioned between the sidewall 43 of the semiconductor layer 26 and the side edge 33 of the pad 24.

The waveguide core segments 14 extend outwardly in a lateral direction from respective portions of the pad 24 at the side edge 30 of the pad 24. In an embodiment, each waveguide core segment 14 may be directly connected to the respective portion of the side edge of the pad 24. Each of the waveguide core segments 14 terminates at an end 38 that is spaced from the side edge 30. In an embodiment, each waveguide core segment 14 may extend from the respective portion of the side edge of the pad 24 to the associated end 38. In an embodiment, the waveguide core segments 14 may have a laterally-spaced arrangement along the side edge 30. In an embodiment, the waveguide core segments 14 may be positioned along the side edge 30 between the sidewall 42 of the semiconductor layer 26 and the sidewall 43 of the semiconductor layer 26.

In an embodiment, the waveguide core segments 14 may be nanostructures that have a width within a range of about one (1) nanometer and about one hundred (100) nanometers. In an embodiment, the waveguide core segments 14 may be uniformly spaced to define a periodic arrangement. In alternative embodiments, waveguide core segments 14 may be non-uniformly spaced to define an aperiodic arrangement. The waveguide core segments 14 may be parameterized according to the wavelength of the arriving light in microns, such as a length L ranging from a few microns to hundreds of microns, a pitch equal to 0.3 multiplied by the light wavelength to 0.7 multiplied by the light wavelength, and a duty cycle equal to 0.1 multiplied by the light wavelength to 0.9 multiplied by the light wavelength. In an embodiment, the centermost waveguide core segment 14 may be lengthwise aligned with the longitudinal axis 22 of the semiconductor layer 26.

The waveguide core segments 14 are tilted at different angles θ relative to each other such that the waveguide core segments 14 fan out or diverge with increasing distance from the side edge 30. In that regard, the waveguide core segments 14 are closer together adjacent to the side edge 30 than adjacent to their terminating ends 38. The angle θ may be measured relative to a normal direction 28 that is perpendicular to the side edge 30. In an embodiment, the normal direction 28 may be parallel to the longitudinal axis 22 of the semiconductor layer 26. In an embodiment, the outermost waveguide core segments 14 may be tilted with the largest angle θ and the centermost waveguide core segment 14 tilted with the smallest angle θ. In an embodiment, the angle θ of the waveguide core segments 14 may increase with increasing distance along the side edge 30 from the longitudinal axis 22 of the semiconductor layer 26 with the outermost waveguide core segments 14 tilted with the largest angle θ and the centermost waveguide core segment 14 tilted with the smallest angle θ. In an embodiment, the angle θ may increase with increasing distance along the side edge 30 from the centermost waveguide core segment 14 such that the outermost waveguide core segments 14 are characterized by the largest angle θ. In an embodiment, the angle θ of the centermost waveguide core segment 14 may be equal to zero (0) degrees.

In an embodiment, the waveguide core segments 14 may be non-tapered ridges. In an alternative embodiment, the waveguide core segments 14 may be non-tapered ribs characterized by ridges having lower portions joined by a thinner slab layer. In an alternative embodiment, each waveguide core segment 14 may be either tapered ridges or ribs with either a single taper angle or multiple taper angles. In an alternative embodiment, each waveguide core segment 14 may taper with a width dimension that decreases with increasing distance from the side edge 30. In an alternative embodiment, the width dimension of each waveguide core segment 14 may linearly decrease with increasing distance from the side edge 30. In an alternative embodiment, the width dimension of each waveguide core segment 14 may change based on a non-linear function, such as a quadratic function, a cubic function, a parabolic function, a sine function, a cosine function, a Bezier function, or an exponential function.

In an embodiment, the waveguide core segments 14 and the pad 24 may be comprised of the same material. In an embodiment, the waveguide core segments 14 and the pad 24 may be comprised of a material having a refractive index that is greater than the refractive index of an oxide of silicon (e.g., silicon dioxide). In an embodiment, the waveguide core segments 14 and the pad 24 may be comprised of a semiconductor material, such as single-crystal silicon. In an embodiment, the waveguide core segments 14 and the pad 24 may be formed by patterning a layer comprised of their constituent material with lithography and etching processes. In an embodiment, an etch mask may be formed by a lithography process over a layer of the constituent material of the waveguide core segments 14 and the pad 24, and unmasked sections of the layer may be etched and removed by an etching process. The shape of the etch mask determines the patterned shape of the waveguide core segments 14 and the pad 24. In an embodiment, the waveguide core segments 14 and pad 24 may be formed by patterning the semiconductor material, such as single-crystal silicon, of a semiconductor layer 16 of a silicon-on-insulator substrate.

The semiconductor layer 26 is comprised of a light-absorbing material that is capable of photoelectric conversion by converting the photon energy of light into an electrical signal. In an embodiment, the semiconductor layer 26 may be comprised of an intrinsic semiconductor material. In an embodiment, the semiconductor layer 26 may be comprised of intrinsic germanium. In an embodiment, the semiconductor layer 26 may be comprised of intrinsic silicon-germanium. In an alternative embodiment, the semiconductor layer 26 may be comprised of a different type of semiconductor material, such as a III-V compound semiconductor material or intrinsic silicon.

The photodetector 12 may include a doped region 46 that is positioned between the side edge 32 of the pad 24 and the sidewall 42 of the semiconductor layer 26, as well as a doped region 48 that is positioned between the side edge 33 of the pad 24 and the sidewall 43 of the semiconductor layer 26. In an embodiment, the doped region 46 may differ in conductivity type from the doped region 48. The semiconductor layer 26 is laterally positioned on the pad 24 between the doped region 46 and the doped region 48. In an embodiment, the doped regions 46, 48 may extend fully through the entire thickness of the pad 24 to the underlying dielectric layer 18. In an embodiment, the doped region 46 may define an anode of the photodetector 12 and the doped region 48 may define a cathode of the photodetector 12. In an alternative embodiment, the doped region 46 may define a cathode of the photodetector 12 and the doped region 48 may define an anode of the photodetector 12.

The doped region 46 may be formed by, for example, ion implantation with an implantation mask having an opening that determines the implanted area of the pad 24. The implantation mask may include a layer of photoresist applied by a spin-coating process, pre-baked, exposed to light projected through a photomask, baked after exposure, and developed with a chemical developer to define the opening over the area of the pad 24 to be implanted. The implantation conditions, such as ion species, dose, and kinetic energy, may be selected to tune the electrical and physical characteristics of the doped region 46. The implantation mask may be stripped after forming the doped region 46. In an embodiment, the semiconductor material of the doped region 46 may contain a p-type dopant, such as boron, that provides p-type electrical conductivity. In an alternative embodiment, the semiconductor material of the doped region 46 may contain an n-type dopant, such as phosphorus or arsenic, that provides n-type electrical conductivity. In an alternative embodiment, a portion of the semiconductor layer 26 adjacent to the sidewall 42 may also be implanted, when the doped region 46 is formed, due to a partial overlap of the opening in the implantation mask with the semiconductor layer 26.

The doped region 48 may be formed by, for example, ion implantation with an implantation mask having an opening that determines an implanted area of the pad 24. The implantation mask may include a layer of photoresist applied by a spin-coating process, pre-baked, exposed to light projected through a photomask, baked after exposure, and developed with a chemical developer to define the opening over the area of the pad 24 to be implanted. The implantation conditions, such as ion species, dose, and kinetic energy, may be selected to tune the electrical and physical characteristics of the doped region 48. The implantation mask may be stripped after forming the doped region 48. In an embodiment, the semiconductor material of the doped region 48 may contain an n-type dopant, such as phosphorus or arsenic, that provides n-type electrical conductivity if the doped region 46 contains a p-type dopant. In an alternative embodiment, the semiconductor material of the doped region 48 may contain a p-type dopant, such as boron, that provides p-type electrical conductivity if the doped region 46 contains an n-type dopant. In an alternative embodiment, a portion of the semiconductor layer 26 adjacent to the sidewall 43 may also be implanted, when the doped region 48 is formed, due to a partial overlap of the opening in the implantation mask with the semiconductor layer 26.

A portion of the pad 24 beneath the semiconductor layer 26 may be comprised of intrinsic semiconductor material, such as intrinsic silicon, that is not doped by the ion implantation forming the doped region 46 or by the ion implantation forming doped region 48. The doped region 46, the intrinsic semiconductor materials of the semiconductor layer 26 and the portion of the pad 24 beneath the semiconductor layer 26, and the doped region 48 may define a lateral p-i-n diode that contributes to the functionality of the photodetector 12.

A heavily-doped region 47 may be formed by a masked ion implantation in a portion of the doped region 46 adjacent to the side edge 32 of the pad 24. A heavily-doped region 49 may be formed by the masked ion implantation in a portion of the doped region 48 adjacent to the side edge 33 of the pad 24. The heavily-doped region 47 may have the same conductivity type as the doped region 46 but at a higher dopant concentration. The heavily-doped region 49 may have the same conductivity type as the doped region 48 but at a higher dopant concentration.

In an alternative embodiment, the photodetector 12 may have a vertical arrangement instead of a lateral arrangement. Specifically, in the vertical arrangement, the doped region 46 and heavily-doped region 47 may be arranged in the pad 24 on one, or both, sides of the semiconductor layer 26, and the doped region 48 and heavily-doped region 49 may be arranged in an upper portion of the semiconductor layer 26. In an alternative embodiment, the photodetector 12 may be configured as an avalanche photodetector that includes an intrinsic semiconductor region in the pad 24 defining a multiplication region and an additional doped region in the pad 24 defining a charge control region.

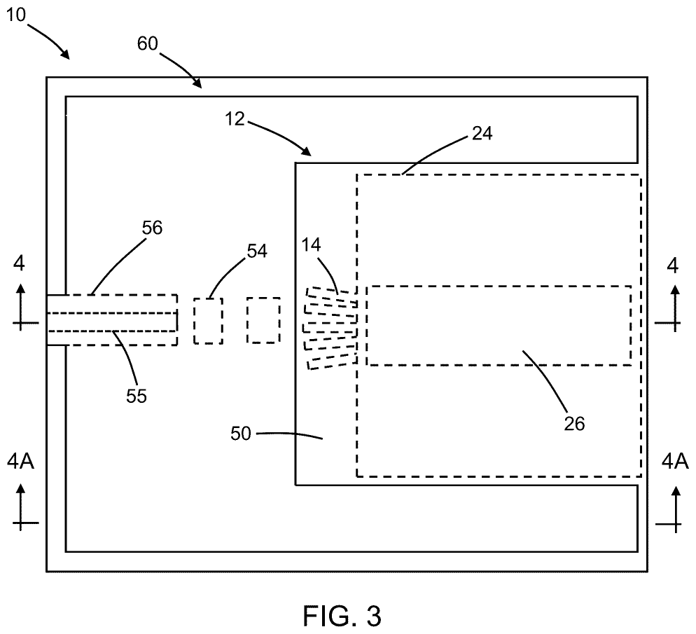

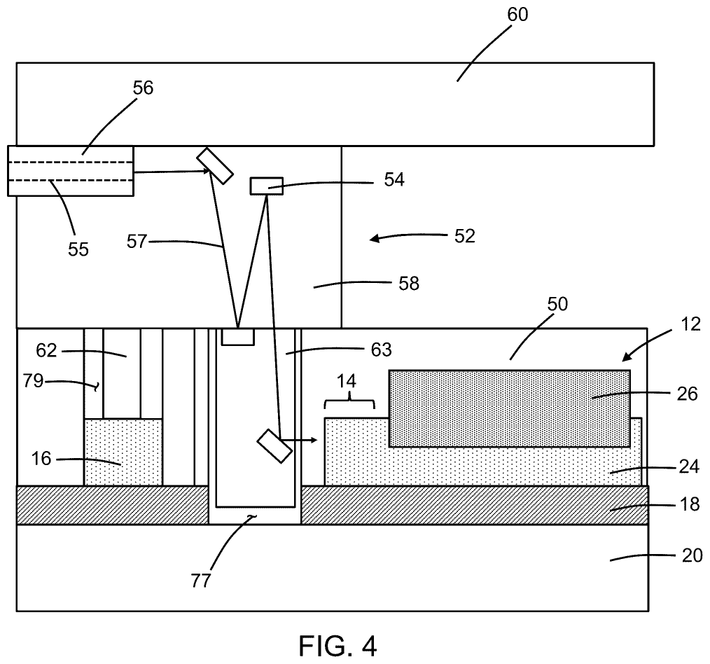

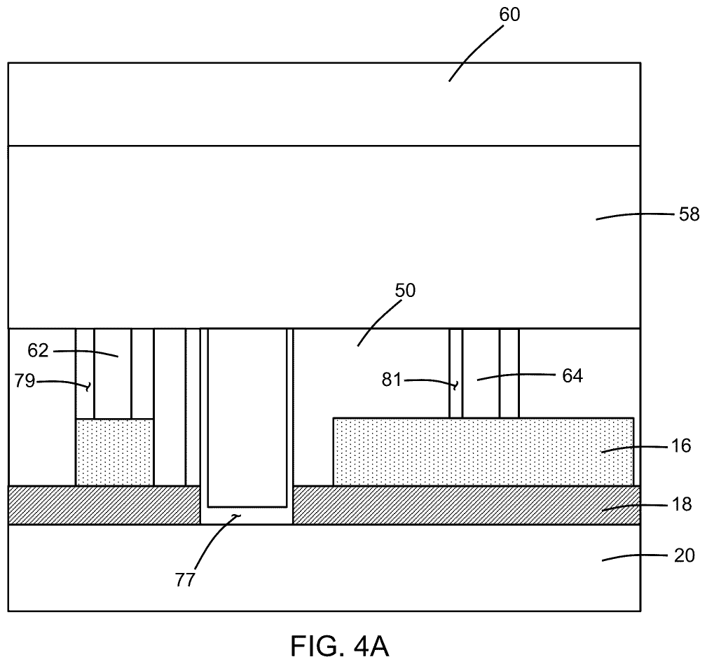

With reference to FIGS. 3, 4, 4A in which like reference numerals refer to like features in FIGS. 1, 2, 2A, 2B and at a subsequent fabrication stage, a dielectric layer 50 may be formed over the photodetector 12 and the waveguide core segments 14. The dielectric layer 50 may be comprised of a dielectric material, such as an oxide of silicon (e.g., silicon dioxide), that is deposited and then planarized following deposition. The dielectric material constituting the dielectric layer 50 may have a refractive index that is less than the refractive index of the material constituting the waveguide core segments 14 and pad 24, as well as less than the refractive index of the material constituting the semiconductor layer 26. One or more conformal dielectric layers (not shown) may be formed over the photodetector 12 before forming the dielectric layer 50. Contacts (not shown) may be formed in the dielectric layer 50 that are physically and electrically coupled by the heavily-doped region 47 to the doped region 46, and contacts (not shown) may be formed in the dielectric layer 50 that are physically and electrically coupled by the heavily-doped region 49 to the doped region 48. The doped region 46 and the doped region 48 may be biased through the contacts.

An opening 77 may be formed that extends through the dielectric layer 50, the semiconductor layer 16, and the dielectric layer 18 to the semiconductor substrate 20. An opening 79 and an opening 81 may be formed that extend through the dielectric layer 50 to the semiconductor layer 16. The opening 77 is located adjacent to the photodetector 12 and the waveguide core segments 14, and the waveguide core segments 14 may be laterally positioned between the opening 77 and the photodetector 12. The openings 77, 79, 81 may be patterned by lithography and etching processes.

The structure 10 may further include a photonic coupler 52 having reflectors in the form of mirrors 54 that are configured to collimate and focus the light received from the core 55 of an optical fiber 56 and to provide the collimated, focused light by multiple reflections in a light path 57 as input to the photodetector 12. The photonic coupler 52 may include a body 58 in which the mirrors 54 may be held in fixed positions. In an alternative embodiment, one or more of the mirrors 54, such as the mirror 54 proximate to the waveguide core segments 14, may be supported in a fixed position by the semiconductor substrate 20 instead of being held by the body 58. In an embodiment, the body 58 may be a layered structure comprised of one or more materials, such as glass, that are optically transparent.

The mirrors 54 of the photonic coupler 52 define beam-deflection optics that direct light from the optical fiber 56 to the photodetector by multiple reflections in a light path 57 having an output that is aligned with the photodetector 12 and the waveguide core segments 14. The body 58 of the photonic coupler 52 may be attached to a die 60 such that the body 58 is positioned in a vertical direction between the die 60 and the semiconductor substrate 20. In alternative embodiments, the photonic coupler 52 may include one or more collimators and/or one or more microlenses in addition to the mirrors 54. The tip of the optical fiber 56 may be attached to the body 58 by a laminated or bonded glass fiber block having a groove shaped for receiving the tip of the optical fiber 56.

The body 58 of the photonic coupler 52 may include a projection 62 that is positioned inside the opening 79 and a projection 64 that is positioned inside the opening 81. The projections 62, 64 may contact different portions of the semiconductor layer 16 and the contacted portions of the semiconductor layer 16 may be coplanar with the pad 24. The projections 62, 64 provide vertical stops for use in aligning the outlet of the light path 57 exiting from the photonic coupler 52 with the waveguide core segments 14 and the photodetector 12. The photonic coupler 52 may include a projection 63 that extends into the opening 77 and one or more of the mirrors 54 may be positioned inside the projection 63.

In an alternative embodiment, the photonic coupler 52 may be omitted such that the optical fiber 56 alone operates as a light source in which the core 55 is aligned with the photodetector 12 and the waveguide core segments 14. In an alternative embodiment, the photonic coupler 52 and the optical fiber 56 may be replaced by a different type of light source, such as a laser, a semiconductor optical amplifier, or a vertical-cavity surface-emitting laser. In an alternative embodiment, the sidewall 40 of the semiconductor layer 26 may include one or more chamfered edges that function to deflect incident light and thereby reduce optical return loss to the mirrors 54 of the photonic coupler 52.

In an alternative embodiment, multiple instances of the structure 10 may grouped to provide an array of photonic receivers. Each instance of the structure 10 may include an instance of the photodetector 12, an instance of the waveguide core segments 14, and an instance of the photonic coupler 52, and each instance of the structure 10 may receive light from its own associated optical fiber 56.

In use, light is transferred by the photonic coupler 52 to the photodetector 12 with the waveguide core segments 14 providing beam shaping. In an embodiment, the light received by the photodetector 12 from the photonic coupler 52 may be modulated as an optical signal. The semiconductor layer 26 absorbs photons of the light and converts the absorbed photons into charge carriers by photoelectric conversion. The biasing of the doped regions 46, 48 causes the charge carriers to be collected and output from the photodetector 12 to provide, as a function of time, a measurable photocurrent.

The photodetector 12 and the waveguide core segments 14 are integrated with the photonic coupler 52 as an assembly on the same semiconductor substrate 20, which enables the formation of a photonic receiver that is more compact that conventional photonic receivers. The waveguide core segments 14 provide beam shaping that enhances the efficiency of the light coupling from the photonic coupler 52, or from free space, to the photodetector 12. The waveguide core segments 14 may function to reduce the mode mismatch between the light arriving from the photonic coupler 52 and the light inside the semiconductor layer 26 of the photodetector 12. The combination of the photodetector 12, the waveguide core segments 14, and the photonic coupler 52 enable photodetection and current generation/signal processing within a single unitary structure 10.

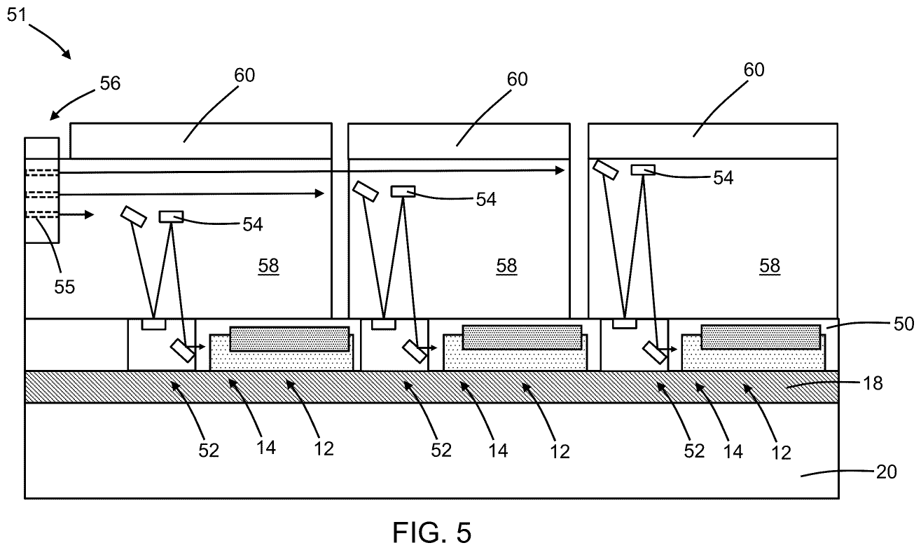

With reference to FIG. 5 and in accordance with alternative embodiments, a structure 51 may include multiple photonic couplers 52 that are integrated with multiple instances of the photodetector 12 and the waveguide core segments 14. The optical fiber 56 may be a multicore optical fiber that includes multiple cores 55 that provide light to the different photonic couplers 52. Each individual core 55 of the multicore optical fiber 56 may support a single mode. The cores 55 of the optical fiber 56 may behave as a bundle of single-mode optical fibers with negligible modal overlap. Each instance of the photonic coupler 52 includes the mirrors 54, the body 58, and the die 60 that is attached to the body 58. The body 58 of each photonic coupler 52 may include the projections 62, 64 (FIGS. 4, 4A) that provide vertical stops for aligning the light path 57 exiting out of each photonic coupler 52 with the adjacent instance of the waveguide core segments 14 and photodetector 12.

In an alternative embodiment, multiple single-mode optical fibers 56 each having a single core 55 may be utilized to provide light to the photonic couplers 52. The single-mode optical fibers 56 may be arranged in a stack or, alternatively, may have a staggered arrangement.

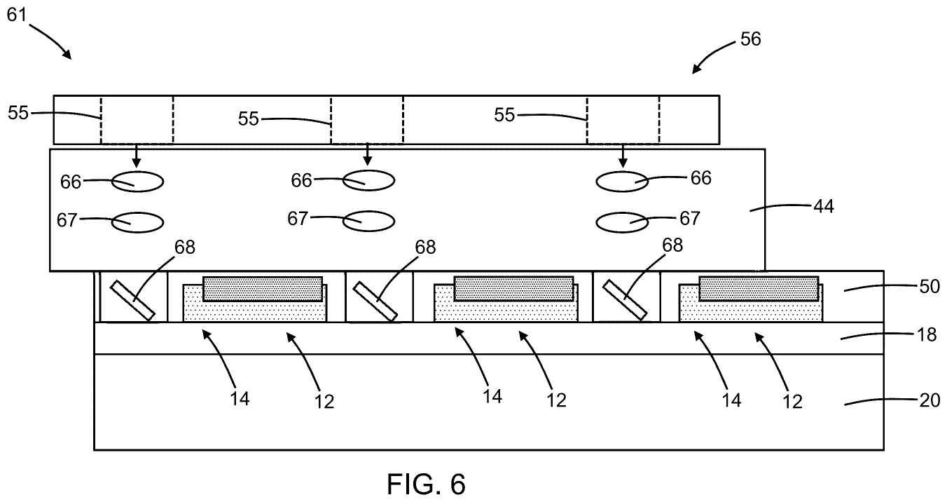

With reference to FIG. 6 and in accordance with alternative embodiments, a structure 61 may include multiple instances of the photodetector 12 and the waveguide core segments 14, as well as multiple instances of a lens 66, a lens 67, and a mirror 68 that cooperate to transfer light from each core 55 of the multicore optical fiber 56 in a light path to one of the instances of the photodetector 12 and the waveguide core segments 14. Each set of lenses 66, 67 may focus or disperse the light received from the corresponding core 55, and the mirror 68 may reflect the light to provide a change in direction to accommodate the horizontal orientation of the instance of the photodetector 12 and the waveguide core segments 14. In an embodiment, the light from each core 55 of the optical fiber 56 may propagate in a vertical direction toward the lenses 66, 67, the mirror 68 may receive the light after passage through the lenses 66, 67, and the mirror 68 may reflect the received light in a horizontal direction toward one of the instances of the photodetector 12 and the waveguide core segments 14.

In an alternative embodiment, multiple single-mode optical fibers 56 each having a single core 55 may be utilized instead of the multicore optical fiber 56 to provide light to the photonic couplers 52. In an alternative embodiment, the mirrors 68 may be omitted and light from the cores 55 may be directed toward the semiconductor layer 26 of each photodetector 12.

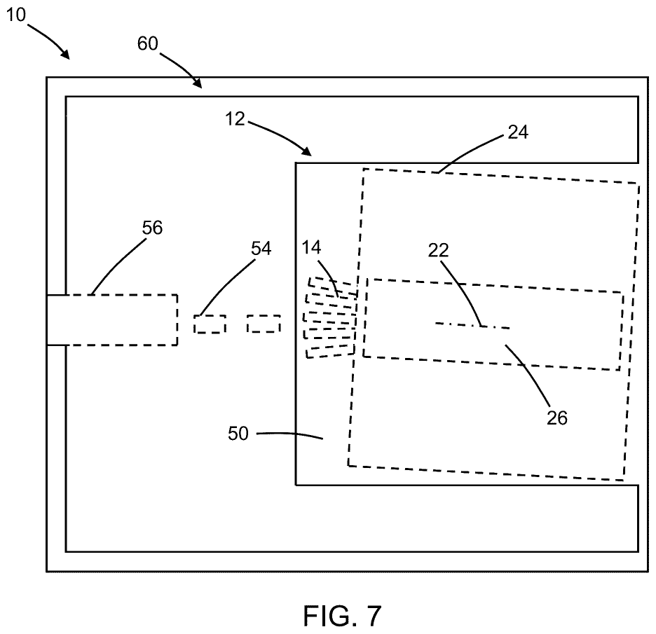

With reference to FIG. 7 and in accordance with alternative embodiments, the photodetector 12 and the waveguide core segments 14 may be tilted such that the light path 57 exiting the photonic coupler 52 is not parallel to the normal direction 28 (FIG. 1). In an embodiment, the longitudinal axis 22 of the semiconductor layer 26 may be tilted such that the light path 57 exiting the photonic coupler 52 is not parallel to the longitudinal axis 22.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure comprising:
a photodetector including a pad with a side edge and a first semiconductor layer configured to absorb light; and
a plurality of waveguide core segments, each of the plurality of waveguide core segments extending outwardly from a respective portion of the side edge of the pad.

2. The structure of claim 1 further comprising:
a photonic coupler including a body and a plurality of mirrors,
wherein the plurality of waveguide core segments are positioned between the body of the photonic coupler and the photodetector.

3. The structure of claim 2 wherein the plurality of mirrors of the photonic coupler are arranged to direct light in a light path from an optical fiber through the body of the photonic coupler to the photodetector.

4. The structure of claim 3 wherein the plurality of waveguide core segments are tilted relative to a portion of the light path exiting the photonic coupler.

5. The structure of claim 2 further comprising:
a second semiconductor layer including a first portion spaced from the pad,
wherein the body of the photonic coupler includes a first projection that is positioned in contact with the first portion of the second semiconductor layer.

6. The structure of claim 5 wherein the first portion of the second semiconductor layer and the pad are coplanar.

7. The structure of claim 5 wherein the first portion of the second semiconductor layer and the pad comprise a semiconductor material.

8. The structure of claim 5 wherein the second semiconductor layer includes a second portion spaced from the pad, and the body of the photonic coupler includes a second projection that is positioned in contact with the second portion of the second semiconductor layer.

9. The structure of claim 1 wherein each of the plurality of waveguide core segments is angled relative to the side edge of the pad.

10. The structure of claim 9 wherein the plurality of waveguide core segments diverge with increasing distance from the side edge of the pad.

11. The structure of claim 9 wherein the plurality of waveguide core segments are angled at different angles relative to the side edge of the pad.

12. The structure of claim 1 wherein the side edge of the pad has a normal, and each of the plurality of waveguide core segments is angled relative to the normal.

13. The structure of claim 12 wherein the plurality of waveguide core segments diverge with increasing distance from the side edge of the pad.

14. The structure of claim 12 wherein the plurality of waveguide core segments are angled at different angles relative to the normal to the side edge of the pad.

15. The structure of claim 1 further comprising:
a plurality of lenses; and
a mirror,
wherein the mirror is configured to reflect light received from the plurality of lenses toward the photodetector and the plurality of waveguide core segments.

16. The structure of claim 1 wherein the first semiconductor layer has a longitudinal axis, and one of the plurality of waveguide core segments is lengthwise aligned with the longitudinal axis.

17. The structure of claim 1 wherein each of the plurality of waveguide core segments is directly connected to the respective portion of the side edge of the pad.

18. The structure of claim 17 wherein each of the plurality of waveguide core segments terminates at an end that is spaced from the side edge of the pad.

19. The structure of claim 1 wherein the first semiconductor layer has a first sidewall and a second sidewall, and the plurality of waveguide core segments are laterally spaced along the side edge of the pad between the first sidewall of the first semiconductor layer and the second sidewall of the first semiconductor layer.

20. A method comprising:
forming a photodetector including a pad with a side edge and a semiconductor layer configured to absorb light; and
forming a plurality of waveguide core segments, wherein each of the plurality of waveguide core segments extends outwardly from a respective portion of the side edge of the pad.
